(19) United States
(12) Patent Application Publication
(10) Pub. No.: US 2025/0217869 A1
(43) Pub. Date: Jul. 3, 2025

(54) AUTOMATED RETAIL SYSTEM CONTROL AND METHOD

(71) Applicant: COSTA EXPRESS LIMITED, Buckinghamshire (GB)

(72) Inventors: Julien Jacques PAROUTY, Austin, TX (US); John Kenneth COX, Austin, TX (US); Scott SNYDER, Austin, TX (US); Nicholas Ryan BOURGEOIS, Austin, TX (US); Chris George LAMBE, Austin, TX (US)

(21) Appl. No.: 18/853,334

(22) PCT Filed: Mar. 31, 2023
(86) PCT No.: PCT/EP2023/058502

§ 371 Date: Oct. 1, 2024

Related U.S. Application Data
(60) Provisional application No. 63/362,360, filed on Apr. 1, 2022.

(51) Int. Cl. G06Q 30/0601; G07F 13/06

(52) U.S. Cl. CPC G06Q 30/0635; G06Q 30/0639; G07F 13/065

(57) ABSTRACT

Provided is a system and method for controlling a plurality of automated retail systems, comprising a controller in communication with a plurality of automated retail systems, wherein the controller is configured to receive real-time information from the automated retail systems in order to determine routing, queueing, and production of order messages.

### TECHNICAL FIELD

The present application relates to a system for operating multiple automated retail systems, and a method of operation for the same.

### BACKGROUND

Automated retail systems are prevalent in many locations; they are found at shopping centres, travel hubs such as stations and airports, as well as service stations, and in office complexes. Automated retail systems typically comprise a user interface located on the body of the machine itself, and a user may place an order through entering their choice(s) and payment via the user interface. Increasingly, users interact with automated systems via an electronic user device which may be personal to the user, rather than interacting directly with a user interface attached to a machine. Users will commonly, interact with the automated retail system from a user device to place orders and receive notifications that payment is complete, or an order is ready for collection, for example. Such interactions may take place over any suitable connection, including Wi-fi, Bluetooth®, NFC (near-field communication) or similar. Prior systems were limited in the information accessible for a user, and were limited in the functionality provided in the event of errors with the automated retail systems.

### SUMMARY

A system for controlling a plurality of automated retail systems is provided, comprising a controller in communication with a plurality of automated retail systems, wherein the controller is configured to: receive a user request to use the system, receive real time status information indicative of resource availability from the plurality of automated retail systems, determine an available product list, based on the received status information, wherein the available product list comprises a list of products which are available at the plurality of automated retail systems, transmit the available product list to the user, receive an order message comprising an order selected from the available product list from the user, select an automated retail system to fulfil the order, and transmit the order to the selected automated retail system.

Optionally, the user request further comprises one or more of user location information, a user selected location and user preference information, and the product list is determined based on the received status information of automated retail systems associated with a location corresponding to the user request.

Optionally, prior to determining the available product list, the controller is configured to query a work in progress data store for automated retail systems associated with the user location information.

Optionally, the user request is received from a remote user device via an internet connection.

Optionally, the status information comprises order state information relating to the orders the automated retail system is in the process of fulfilling.

Optionally, wherein the product list transmitted to the user comprises estimated wait time information for each product based at least in part on queue information.

Optionally, to transmitting the order to the selected automated retail system, the controller is configured to place the received order in a queue of orders that the selected autonomous retail system is to fulfil.

Optionally, the order message comprises a user timing request to pre-schedule an order, or delay an existing order, and the controller is arranged to place the order in the queue of orders based on the user timing request.

Optionally, the product list is dynamically updated based on changes to the real time status information and transmitted to the user, and the available product list is determined based on the status information and one or both of the user location information and the location selection.

Optionally, a first portion of the available products are available on a first automated retail system and a second portion of the available products are available on a second automated retail system.

Optionally the automated retail systems are automated retail kiosks, and optionally wherein the automated retail kiosks are automated beverage making machines.

Optionally, the processor is configured to select a first automated retail system to complete a first part of the order, and a second automated retail system to complete a second part of the order.

Optionally, the selecting of an automated retail system to fulfil the order is based on the user request and the status information to minimize the time taken to complete an order.

A method is provided, comprising, at a controller of a system of automated retail systems;
receiving a user request to use the system, receiving real time status information indicative of product availability from a plurality of automated retail systems in communication with the controller, determining an available product list based on the received status information, the available product list comprising a list of products which are available at the plurality of automated retail systems, transmitting the available product list to the user, receiving an order message comprising an order selected from the available product list from the user, selecting an automated retail system to fulfil the order, transmitting the order to the selected automated retail system.

A computer readable medium comprising instructions which, when executed, cause a processor to perform the steps of the method of claim 14.

### BRIEF DESCRIPTION OF THE DRAWINGS

Specific implementations of the present disclosure are described below in the detailed description by way of example only and with reference to the accompanying drawings, in which:

FIG. 1a illustrates an example system 100 according to the present disclosure.

FIGS. 2 to 7 illustrate a data flow diagram according to the present disclosure.

FIG. 8 illustrates a flowchart of a process for fulfilling a user request in accordance with a system according to the present disclosure,

FIG. 9 illustrates a block diagram of one implementation of a computing device 1100 within which a set of instructions, for causing the computing device to perform any one or more of the methodologies discussed herein, may be executed.

Like reference numerals are used for like components throughout the drawings.

### DETAILED DESCRIPTION OF THE DRAWINGS

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology

In overview, and without limitation, the application discloses a system for controlling operation of a plurality of autonomous retail systems, and a method of operation thereof. The system comprises a controller arranged to coordinate a customer interface, as well as order fulfilment, routing, and queueing for a plurality of autonomous retail systems to which it is connected via an internet connection. The controller of the system receives control and feedback data from both user devices and other external systems including content management systems, and the like. From a user perspective, a user device may be used to access a software application so as to view a schedule of items available from the plurality of autonomous retail systems, the application being updated in real-time by the controller.

The autonomous retail systems may collect and transmit real-time state data to the controller via a data connection, for example an internet connection, such that the controller may receive information about performance of functions at the autonomous retail system, including, for example sub-component operation states, as well as perishable resource levels The state data received by the controller allows it to provide and update the schedule of items so as to provide the user with a single interface for accessing multiple autonomous retail systems. For instance, a user may view a range of products that are available at the plurality of autonomous retail systems; some of the products that are presented in the schedule may be available at a first autonomous retail system only, and not at others, while some products may be available at various autonomous retail systems. The availability of the products may be dependent on the system states of the autonomous retail systems, which are communicated to the controller.

Once the user places an order from the schedule, the controller may then select one or more autonomous retail systems to fulfil the order, and then transmit the order or relevant parts of orders to the selected autonomous retail system(s). That is, individual parts of an order may be completed by different systems-the controller may communicate directly with producers within an autonomous retail system, described as workcells below; the controller may thus select a specific first workcell of an autonomous retail system to complete an order, and may alternatively select a specific first workcell of an autonomous retail system to complete a first part of an order, and a second specific workcell, which may or may not be in the same autonomous retail system, to complete a second part of the order. The selection of the workcells, described as routing, below, may be carried out as further described below.

The autonomous retail systems may be grouped by location, for example within a larger retail setting such as a shopping mall, or office building, or airport, for example. The provision of the controller and the control and feedback provided by the autonomous retail systems to the controller allow for the federation of multiple systems, that may have different fulfilment capabilities.

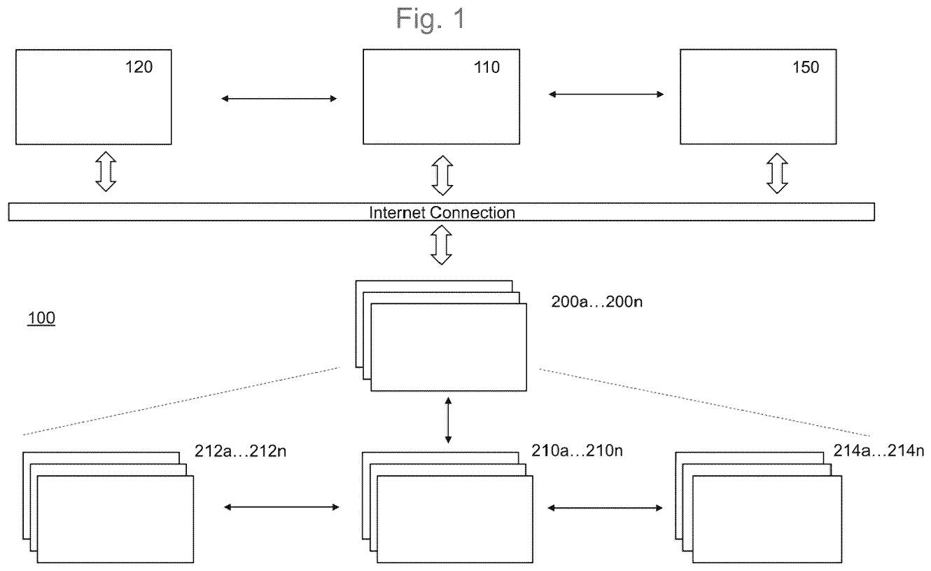

FIG. 1 shows an example system 100 according to the present disclosure. The system 100 comprises a controller 110, which communicates with a plurality of autonomous retail systems 200a . . . 200n. The plurality of autonomous retail systems 200a . . . 200n may each comprise a plurality of fulfilment workcells 210a . . . 210n, as well as components 212a . . . 212n, and resources 214a . . . 214n associated with respective fulfilment workcells 210a . . . 210n. Autonomous retail systems 200a . . . 200n may comprise systems of varying type and capability; for example the system 100 may comprise automated beverage makers 200a, 200b, 200c, standard automated vending machines 200d, 200e, etc. . . . Herein we refer to autonomous retail system 200, which may be of any type relevant in the context of the embodiment described.

The controller 110 may communicate with the plurality of autonomous retail systems 200a . . . 200n via a wired or wireless connection. The controller 110 may be a cloud controller.

Where an autonomous retail system 200 comprises multiple fulfilment workcells 210a . . . 210n, the autonomous retail system 200 may transmit control signals to each fulfilment workcell 210a . . . 210n independently; i.e. the fulfilment workcells of an autonomous retail system 200 may operate independent of each other.

Herein “components” 212 may refer to consumable goods for use in the fulfilment of orders at the fulfilment workcell 210. In the case of an automated beverage production system the components 212 may comprise e.g. coffee beans, water, refrigerated or non-refrigerated additives to be combined in the making of beverages such as coffee drinks, cups and lids. Herein, “resources” 214 may refer to the functional parts of a fulfilment workcell 210. Again, in the example case of an automated beverage making system the resources 214 may comprise e.g., a coffee engine/coffee making machine, an ice dispenser, a cup de-nester, a cup lidder mechanism, a carousel, valves, pumps, sensors, and one or more robot arms.

A fulfilment workcell 210 may provide control signals to resources 214, and may receive feedback signals from the components 212 and resources 214, which will be described further below.

The controller 110 communicates with one or more user interfaces 120. The user interfaces 120 are shown in FIG. 1 as communicating with the controller via the internet connection. The user interfaces also may communicate with the autonomous retail systems 200 via the internet connection. One or more user interfaces 120 may be associated with specific autonomous retail systems 200, or may each be associated with a plurality of autonomous retail systems 200. The user interfaces 120 may comprise one or more of a touchscreen, payment terminal, RFID reader, camera, microphone, speaker, soft (ware) keyboard, barcode reader, GPS unit, and allow the user to interact with the system. A user interface may be provided as a software application to be accessed via a user device such as a mobile phone. The user may interact with the software application, view data regarding the system, and through the user interface on the mobile device input order information to be sent to the controller via the internet connection.

The controller may communicate with various other external systems via the internet connection, including, but not limited to a content management system or similar.
The content management system provides content assets like images, video and menu configuration data (e.g., product metadata for nutrition facts). The user interface queries the content management systems to request assets to present to the user, retrieves the assets from the content management system and presents them.
Content assets may represent default assets for a given market and language, or promotional assets tied a seasonal or special promotional campaign.

The controller 110 may communicate with a data store (not shown) to access data about the system. The data store may comprise at least a location data store 402, a product data store 502 and an order data store 802. Such data may include, but is not limited to.
Data that represents details of specific user orders, which products comprise the orders, as well as modifications and customizations. These details comprise all of the data that are transmitted to the workcells 210 to allow the workcell to complete the order
Data that represents products, product recipes, product variations and product modifications rules.
Data that represent storefront geolocation, associated kiosk(s) and kiosk state (open, closed, public, hidden, i.e., in restricted access location), etc.

The autonomous retail systems 200 may be referred to as kiosks in the following. A kiosk 200 may comprise multiple workcells 210a . . . 210n, the workcells 210 being arranged to fulfil orders that are received from the controller 110 on the basis of a user input to a user interface 105. The kiosks 200 receive instructions from the controller 110 and pass the instructions to the workcell 210 to which they are assigned by the controller 110. A workcell 210 uses the necessary resources 214 to combine the components 212 to produce the products that are part of the order. The kiosk 200 may be considered a stateful machine-the kiosk 200 comprises a processor, a memory and operating circuitry. The kiosk 200 does not store any order history in the memory, but the memory may comprise current machine state information, including an order in-progress state-comprising of individual drink production and delivery state, as well as consumable and resource availability. The order-in-progress state may comprise a status of one or more orders for which instructions have been received, but that are not yet completed. The kiosk state and messaging flows between the kiosks 200a . . . 200n will be described further below. The production workcells 210a . . . 210n present in a kiosk 200 may comprise proprietary and shared resources, that is, some resources 214a . . . 214n and some components 212a . . . 212n of the kiosk 200 may be accessible to multiple workcells, and some will be usable only by a specific workcell 210.

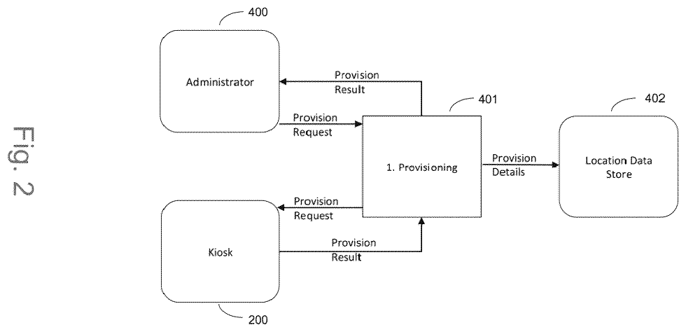

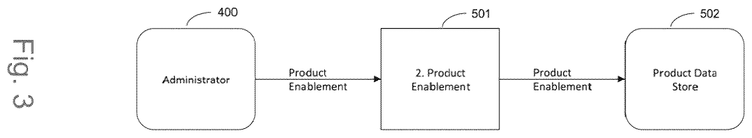

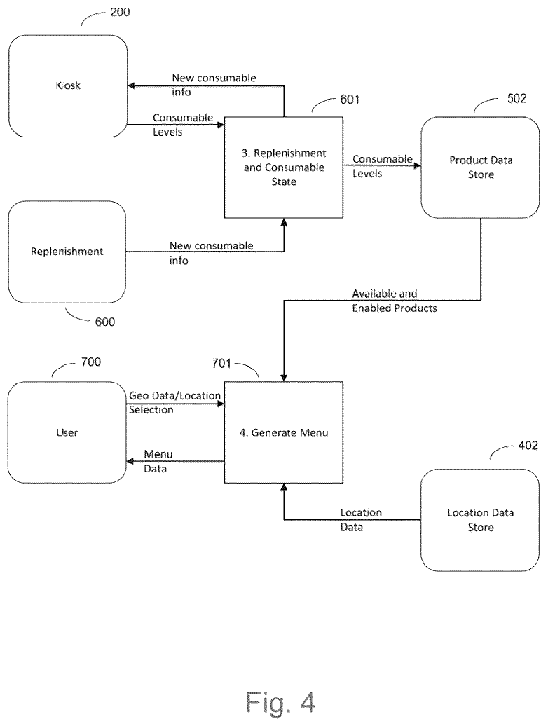

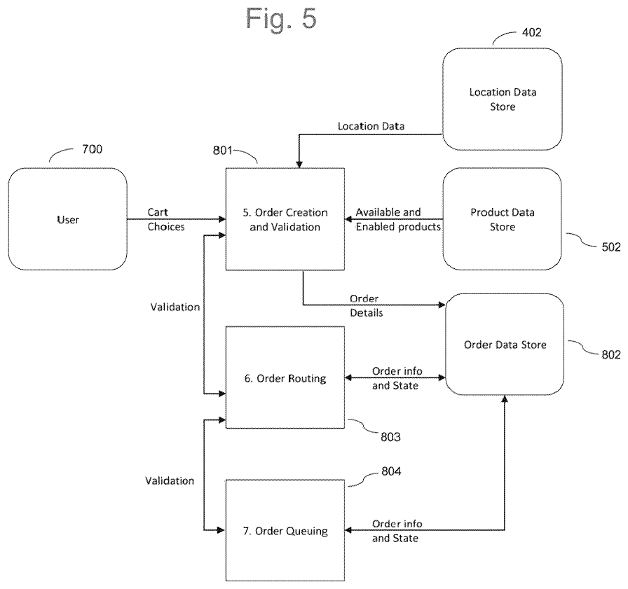

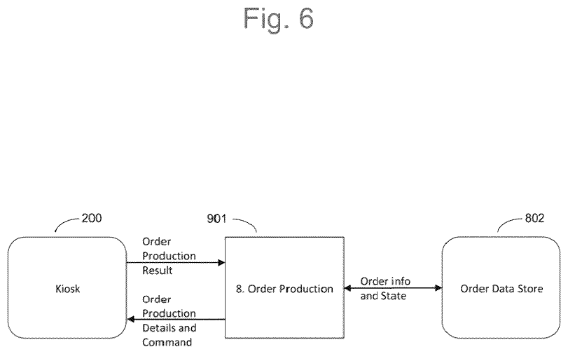

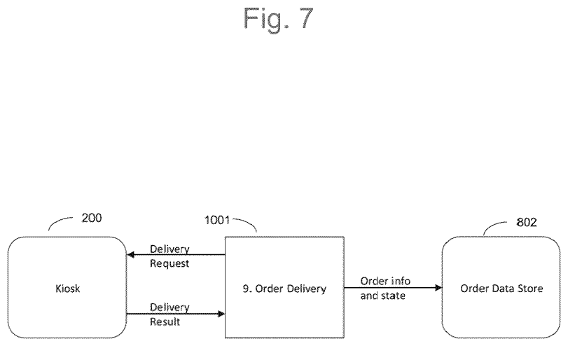

FIGS. 2 to 8 shows a data flow diagram according to the present disclosure. The data flow is a diagrammatic overview of the controller functionality within the system. An administrator 400 may perform the provisioning 401 of the kiosks 200 of system 100. The Administrator 400 may access the system and controller 110 from or via a user interface 120. The administrator 400 may cause the sending of a provisioning request from the controller to a kiosk 200; the provisioning request may include various setup information to configure the kiosk 200, including but not limited to kiosk name, date, group data, location name data, and associations with further kiosks, for example. The provisioning request may also include any instructions to perform software and firmware upgrades that may be required. In response to receiving the provisioning request, the kiosk 200 may perform any configuration steps, and update any local memory as necessarily required by the instructions contained in the provisioning message. When the kiosk 200 has performed the configuration steps it may respond to the controller 110 with a provisioning result message, which may comprise a “setup complete”, “available” or “need more information” status message. The administrator 400 may then be provided with the results of the provision request, in order that they know that the system configuration is as intended. The controller may instruct that the details of the system, including the provisioned kiosk(s) 200a . . . 200n and their characteristics are stored in a location data store 402.

The administrator 400 may perform the product enablement 501 for the system. The individual kiosks 200a . . . 200n and their associated workcells may in principle be arranged to produce any combination of the available components 212a . . . 212n available to them. The administrator 400 provides information relating to a product list that may be produced by kiosks 200a . . . 200n at the individual kiosk and/or the kiosk group level. For example, a given product may be enabled to be produced by kiosks in a first location, but not in a second location, due to regional variations in desirability of certain products over others. Equally the physical state of some kiosks and or locations may mean that production of certain products is not possible at that kiosk and/or location due to the constraints of the individual kiosk resources 214a . . . 214n. The administrator 400 creates, enables, and stores a set of instructions that may be associated with one or more kiosks and used to instruct said kiosk 200 to produce a given product. The instructions may comprise a list of ingredients (components 212a . . . 212n) and target values (e.g., water temperature, additive temperature, additive volume and/or strength) for the control of the workcell resources 214a . . . 214n to be used in the creation of the product. The enabled product(s) list and instructions are stored in a product data storage 502 for use, as described below.

The kiosks 200a . . . 200n monitor the levels of any consumables with which they are provided. In the case of an automated beverage making kiosk, for example, the levels of drinks ingredients such as milk, coffee beans, sugar, syrups, and the levels of cups and lids may be monitored. The levels may be monitored in multiple ways. The weights or volumes of the individual consumables may be monitored through the use of known control and feedback units, such as for example load cells to measure liquid or granular ingredients, photocells for detecting presence of items such as cups or lids. Feedback units may provide availability status messaging to the controller 110 derived from resource error conditions, which may be provided by flow meters provided on or in communication with pipes or nozzles, or temperature sensors for measuring ingredient temperatures. Equally the kiosk 200 may be provided with new consumables information to the effect that when the resources are replenished, data may be entered to the user interface 120 regarding the amount of any resource that is provided to the machine. This may be entered directly, or a machine operator may provide a scan of a bar-or QR-code which may be read by the user interface 120, to the effect that the quantity data for that component is provided to the controller and be stored in the product data store. Consumable state data may also comprise expiry data for consumable product ingredients, or “remove-by” data, indicating a time by which a consumable product may no longer be provided to a user and must be replaced. Each time an order is fulfilled at a kiosk 200, the kiosk 200 may decrement a stored state value relating to each of the consumables or components used to fulfil the order, and transmit the updated kiosk state data to the controller 110. The kiosk consumable state data is transmitted in real-time to the controller 110 and the information is stored in the product data store 502. The state of the kiosk is communicated to the controller and stored at the product data store 502 in order that an up-to-date store of available and enabled products is held.

Effectively, the replenishment and consumable state data 601 of the kiosk(s) 200a . . . 200n flows “upstream” to the controller, and any event that takes place-order production; cleaning; or priming of the machine, for example—is reported in real-time via the internet connection to the controller 110 and updated in the product data store 502.

A user 700 wishing to use the system may make a request to view the available resources through an application running on a computing device such as a mobile device. The application may be provided on a user equipment device (such as a mobile telephone, tablet computer, laptop or other internet-enabled device), or via a user interface 120 provided at a kiosk 200 or other location. The user request may comprise geo-location data or a location selection. The geo-location data may be provided based on GPS data acquired from the user equipment, for example. The user 700 may alternatively select from a list of location options that may be presented to them via the user interface of their device. A generate menu function 701 is performed on the basis of a receipt of a user request. The geo-location or location selection is matched to the available kiosks, data for which is held in the location data store 402. The available and enabled product information is obtained from the product data store 502 and a menu of available products is generated. The menu provided to the user 700 may comprise products from kiosks 200a . . . 200n having different types and capabilities; the product information stored at the product data store 502 relates to, for example a first kiosk 200a having a first set of enabled products, and a second kiosk 200b comprising a second list of enabled products, which may overlap with but not be identical to the first list. The enabled product list information may be modified in real-time subject to the feedback and control data provided by the kiosks 200a . . . 200n or administrator action to generate the available product data that is provided to the user 700. The product list may be updated by the controller 110 itself; for example products may be made available on a scheduled basis, at a specific time of day or day of the week, or for one-off periods, as required.

The generated menu data is then transmitted or presented to the user 700. In this way, a user 700 is provided with up to date information on the system and products available at or in the vicinity of the location information provided. Advantageously, the menu that is presented to the user 700 is an up to date representation of the available and enabled products for the kiosk 200 or kiosks 200a . . . 200n in their location, and thus the user 700 is not presented with a menu of choices comprising products that may not be available due to a kiosk or workcell being inactive, too busy, or an ingredient for a particular product having run out. The generated menu data provided to the user 700 may include parts of the machine state information, such as an estimated queue length at a given kiosk 200a, or an estimated delivery time of the order. The estimated queue lengths and estimated delivery time of products from an order may be based on order queueing information that is accessed by the controller. The menu may be viewed via a graphical user interface (GUI) of the application on the user device, or on a display at a kiosk at which the user is located.

The user 700 may select a product or products from the menu provided, and create an order based on their choices. The user may be presented with a series of options for modifying the products provided in the menu. The list of products provided to the user may be considered as “base” products, comprising attributes that may be varied by the user. Attributes of the products may be provided to the user, and values of the presented attributes may be amended incrementally or continuously between predetermined upper and lower limits. For example, in the case of a beverage making system, the user may specify a temperature of the drink, or may add further shots of coffee, or further measures of syrup to a base product, where the base product is a product comprising default values for the ingredients. Example user-defined attributes may be a base cappuccino, with standard coffee settings, modified as: “extra hot”—i.e., with milk heated to a higher temperature than for the base drink; with an extra shot of hazelnut syrup. The user selects a product and defines or specifies the attributes that they wish to, and submits the selected products as an order to the controller. The order comprising the user selection information is transmitted to the controller 110. The order may further comprise user information, payment information etc. as well as the selected products that form the user order

The controller 110 may then validate the order. The order validation is done based on the real-time information that is received from the kiosks 200 and relayed to the controller through the updated product and location data stores. It may be the case, for example, that a user 700 is presented with a menu of available products, but that in the time between presentation of the menu and receipt of the user selection a product or products may have become unavailable, due to a kiosk. 200 experiencing an error state, or completing an in-progress order and updating its consumable state information, which is transmitted to the product data store 502. In this case the order will not be validated if one or more of user-selected products in the order has become unavailable in the time between the menu generation 701 and the order creation and validation 801 functions, and the user 700 may be re-presented with an updated menu of available products for the kiosk(s) present at the user's location. The order may be re-validated at the time of routing and queueing the order, and also at the time of transmitting the order production information to the specific workcells, as described further below.

The user order is first validated when a user selection is matched to the available and enabled product data and the location data that is provided to the controller 110. The validated order details may then be routed to a particular kiosk workcell. The order routing 803 performed by the controller may include selection of a particular production workcell at a kiosk 200 based on a number of different criteria. For example, order routing 803 may be based on the work-in-progress (WIP) queue of the production workcells 210a . . . 210n of kiosks 200a . . . 200n. The order routing 803 of an order made via a user device may be routed in consideration of the use of a user interface of a kiosk. 200 at the moment that an order is to be routed. The use of a user interface 120a located at a kiosk 200a to create an order is indicative of that same kiosk 200a being preferable for the production of the order, and the use of the user interface 120a may be transmitted to the controller such that another concurrent order received remotely from a user device may be routed to a second kiosk 200b. In effect the user 700 already located at the user interface 120a may be given priority over the routing of an order to kiosk 200a over a second user that is using a remote user device. The creation of an order at the user interface of a kiosk 200a may therefore be a synchronous process—such an order will be prioritised over a remotely received order from a user device. The orders received through the application running on a user device are therefore asynchronous, and subject to order queueing 804.

Order routing 803 may take place so as to perform load balancing of orders-where a workcell 210a in kiosk 200a has an associated WIP queue length exceeding a predefined threshold, the controller may be configured to not route an order to the kiosk 200a. The controller 110 may select the production workcell 210 having the shortest WIP queue and determine to route the order accordingly. The controller may route an order based on the known replenishment and consumable state 601 of the kiosks 200a . . . 200n. An order may be routed to a specific kiosk where it is known that a component or components are reaching an expiration date or remove-by date, in order to use the ingredients and minimize waste. The order may further be routed on the basis that machine components of workcells 210a . . . 210n within the kiosks 200a . . . 200n are over-or under-utilised, to thereby maximise the functional life of the workcells 210a . . . 210n and kiosks 200a . . . 200n. In another example, an order, or part thereof, may further be routed on the basis that consumer traffic is to be directed to a pre-selected subset of the kiosks 200a . . . 200n, to thereby increase consumer traffic in that location to the benefit of a third party such as adjacent food outlet, entertainment venue, consumer goods outlet, etc with which there is a commercial relationship. The real-time kiosk and workcell resources and components information that is received by the controller 110 allows for the routing of an order to a particular workcell 210a that is known to be able to produce the order.

The order information and state information is held at an order data store 802. Once an order is created, the order may then be placed in an order queue for completion at a workcell 210 of a kiosk 200. The controller 110 may place the order in a WIP queue held at the controller side. The WIP queue of a workcell includes order information including state information about the order.

An order present in the WIP queue assigned to a specific workcell may be re-routed in the event that a workcell 210a of a kiosk 200a becomes unable to produce the order and transmits an error message to the controller 110. Order re-routing may occur in the event that an asynchronous order in a WIP queue remains in the WIP queue of a specific workcell 210a for longer than a pre-determined period—this may occur where one or more synchronous orders are placed while the asynchronous order remains in the WIP queue. Where an item in the WIP queue of a production workcell 210a exceeds the threshold period, the controller 110 may reroute the order to another production workcell 210b, or provide the user 700 with information relating to the re-routing of the order. Alternatively, or additionally, the user 700 may be required to provide an input validating the re-routing of the order. Upon receipt of the user validation, the controller 110 may reroute the order to a different workcell 210b, and place the order in a WIP queue, if one is current for the selected workcell 210b.

Once an order, or part thereof, has been queued for production at a particular workcell 210a among the workcells and the order reaches the “front” of the queue, order production information and commands are transmitted by the controller to the workcell 210a of the kiosk 200a. The order production information only comprises the instructions required to make the products from the order that have been routed to workcell 210a, to the user-selected attribute-specification that has been validated by the controller. The workcell may require no knowledge of any “base product” specification” as outlined in relation to the menu items described above; the workcell only requires the instructions for the product that is to be made. The order production information may specify that the order production be completed by a plurality of workcells 210a . . . 200n at one or more kiosks 200, to the effect that an order may comprise multiple products that are to be produced in parallel at a kiosk 200a. During production of an order, the workcells transmit (order item) production state information to the controller 110, which is thus able to manage the production of an order in the event of an error in the production of an order product at a production workcell 210. The system 100 is thus provided with failover capability in the event of errors. The controller 110 may re-create, re-try or simply re-route all or part of an order that has failed based on an error message received from a workcell or failure of a workcell to provide an order production result notification to the controller within a predetermined period. A re-routed order may be treated as a new synchronous order and be provided to a workcell for immediate production.

When the products from an order or part of order specified in the order production information are completed by a production workcell 210a, an order production result is transmitted to the controller 110, which updates the order information and state information held in the order data store 802. If the order is not ready for delivery, the controller may instruct the workcell 210a to store the product or products from the order in a staging area of the kiosk 200a, to await delivery to the user 700.

The controller may transmit an order delivery message to a workcell 210a, and the workcell 210a may then deliver the order to the user 700. The workcell 210a transmits an order delivery result to the controller 110, which updates the order information and state at the order data store 802. The workcell 210a that delivers the order may or may not be the production workcell that produced the order. The staging area of a kiosk 200a may be accessible by multiple production workcells 210a . . . 210n such that an order produced at a first production workcell 210a and stored in the staging area may be delivered to the user 700 by a second production workcell 210b.

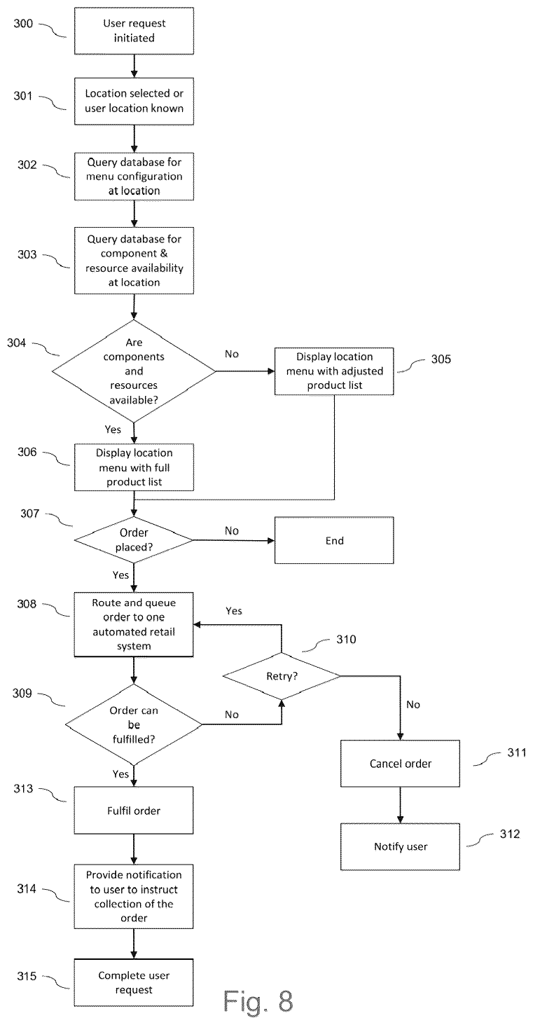

FIG. 8 shows a flowchart of a process for fulfilling a user request in accordance with a system according to the present disclosure. At 300 a user request is initiated and transmitted to a controller of an autonomous retail system, analogous to the system described in the foregoing. The user request may be received from a user device, such as a mobile device (see above) or at the user interface of an automated kiosk 200 of the autonomous retail system. The user request comprises location information (at 301). In the case that the user request is from a remote user device, the location information may comprise a location selection, or it may comprise location information determined based on the location of the device; this may be provided by GPS data on a GPS enabled user device, or may be provided by other means, for example the location data relating to the user's connection to the internet, such as IP or other network information data. Alternatively, where the user request is received from a user interface located on an automated kiosk 200, the location data of the kiosk 200 is provided with the user request. At 302, the controller of the autonomous retail system queries a database for menu configuration at the location corresponding to the location data provided with the user request—here the “location” may comprise one or more kiosks. The menu configuration stored at the database includes information about autonomous retail kiosks 200a . . . 200n enabled in the system, and the products that are enabled at the one or more production workcells provided at each kiosk 200. The menu configuration information may be considered the “base menu” for a given location, that is the list of products that are enabled across the workcells and kiosks that correspond to the user's given or determined location.

At 303, the controller queries the database for this real-time workcell component and resource availability. The real-time component and resource availability may include, as described above, information relating to the amount of consumables available at a workcell of a kiosk 200, as well as performance information regarding the operable parts of the workcell, and whether for example the machine is fully operational, or whether any parts of the machine are malfunctioning. The controller may poll the order data store for WIP information of the available kiosks, in order to provide estimated wait time information to the user with the menu, so that the user may select products based on the wait time.

At 304, the controller determines whether all components and resources of the workcell(s) and kiosk(s) of the user's location are available based on matching the component and resource availability for the location with the menu configuration for the location. In the event that not all of the components and resources of a workcell are available, a location menu is generated with an adjusted product list (at 305). Only the products that are both enabled and available at the location at the time of the user initiated request form part of the adjusted product list. Any enabled products that are not able to be produced due to local lack of consumable components, or due to errors with workcell resources are disabled within the menu configuration information. A disabled item may be visible to the user in the menu, but may not be selectable by the user. The adjusted product list menu is displayed to the user 700. Additional messages may be displayed to the user in the event that an item on the order cannot be validated after the order is placed.

Where alternatively all components and resources are determined to be available at the workcells (and kiosks) at the user location an unimpaired menu of the available and enabled products is provided to the user 700 at 306.

At 307 the system awaits the placing of an order by the user 700. Where no order is placed within a predetermined time period the process may end, or a notification prompt may be transmitted to the user device.

At 308 an order is placed by the user 700 and the order information is transmitted to the controller and at 309 the controller performs the routing and queueing of the order to one or more automated retail systems. The order information may include a request to schedule the production of a product immediately, or at a specified future time, or may include a request that the order be delayed for a predetermined period. The controller may route and queue the entire order to a specific workcell of an automated retail system, or the order may be split across multiple workcells. The routing and queueing of an order may be done depending on state information received from the workcells of the kiosks 200a . . . 200n at the user location, and the routing decision may be based on WIP queues at each workcell. The controller may perform load balancing of the system and ensure that each workcell maintains a WIP queue of similar length. The load balancing may be done on the basis of the historical data received from the kiosks and the usage patterns of the workcells within each kiosk 200; for example a particular workcell may be determined to receive more synchronous orders than another workcell that is part of a kiosk 200, a default condition may be implemented to route asynchronous orders to the workcell that receives fewer synchronous orders, to maximise the time between necessary servicing and repair of a workcell or kiosk. The order queueing may be done based on other information received with the user order, such as estimated journey time or arrival time in the event that the user 700 is not present at the kiosk location. The order queueing may be done to minimize the time between production of the order and presentation of the order to the user.

When the order is at the “front” of the WIP queue and is ready for production, the controller determines whether the order can be fulfilled at 309. The controller may verify that the workcell state information has not changed during the period in which the order has been in the WIP queue. If the workcell state information indicates that the workcell has an error state the process proceeds to 310 where it is determined whether to retry the order at 310. The order may be re-tried and the method returns to 308 for routing and queueing. Alternatively, if it is determined that the order may not be fulfilled the order is cancelled at 311, and a notification is provided to the user 700 at 312. Any payment already taken for the order, by means of in-application or third party payment systems may be refunded in the event that the order is cancelled.

If at 309 the controller verifies from the machine state information that the order can be fulfilled, the controller sends order fulfilment instructions to the selected workcell or workcells to fulfil the order (at 313). An order comprises order production information relating to each item in the order, and it is this which is transmitted to the relevant workcell(s). The order items may be sent to different workcells 210 for production and completion. Each order item is associated with fulfilment instructions. The order item fulfilment instructions comprise all of the information required by the workcell to complete the order item., including, product type, product attribute variations, product modifications, quantities and values (e.g. temperature). The distinction between an order and an order item is important. An order may comprise of multiple order items and kiosk 200 in the present system has no awareness of orders or customers, only order items specified by the order item production information.

At 314, a notification is provided to the user 700 to instruct collection of the order. The notification may comprise location information relating to the workcell or workcells that have produced the order. The location information may comprise time information instructing the user 700 that collection may be possible at or until a specific future time.

At 315 the user request process is completed.

The system and method described above relate to a federated collection of automated kiosks. The kiosks themselves are arranged to transmit state information “upstream” to the controller that may be located in the cloud. The controller maintains and accesses a location data store 402 comprising information linking kiosks to particular location information, as described above. The controller also maintains and accesses a product data store 502 which comprises information relating to products that are enabled within the system, and linking the products to specific automated kiosks in the system that are capable of creating the products using the resources and components of the kiosk, or workcell within the kiosk. The controller may receive and transmit messages via a network interface device across a network connection, to user devices, to the data stores and to the automated kiosks and workcells individually. The controller may communicate via a wired or wireless local, area or internet connection with any of the entities described in the foregoing.

The approaches and methods described herein may be embodied on a computer-readable medium, which may be a non-transitory computer-readable medium. The computer-readable medium carrying computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Example forms of storage medium include, a floppy disk, a flexible disk, a hard disk, a solid-state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

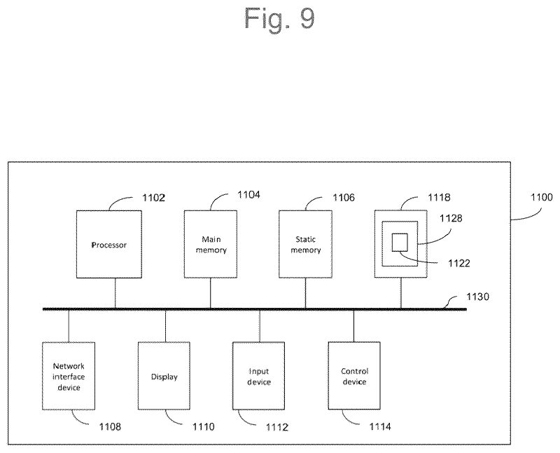

FIG. 9 illustrates a block diagram of one implementation of a computing device 1100 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 1100 includes a processing device 1102, a main memory 1104 (e.g., read-only memory (ROM), flash memory, dynamic random-access memory (DRAM) such as synchronous DRAM (SDRAM) or Rambus DRAM (RDRAM), etc.), a static memory 1106 (e.g., flash memory, static random access memory (SRAM), etc.), and a secondary memory (e.g., a data storage device 1118), which communicate with each other via a bus 1130.

Processing device 1102 represents one or more general-purpose processors such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. Processing device 1102 is configured to execute the processing logic (instructions 1122) for performing the operations, methods and steps discussed herein.

The computing device 1100 may further include a network interface device 1108 for accessing a network connection. The computing device 1100 also may include a video display unit 1110 (e.g., a liquid crystal display (LCD) or light-emitting diode (LED) display, an alphanumeric input device 1112 (e.g., a keyboard or touchscreen), a cursor control device 1114 (e.g., a mouse or touchscreen). The alphanumeric input device 1112 and the cursor control device 1114 may be considered together as a single input mechanism.

The data storage device 1118 may include one or more machine-readable storage media (or more specifically one or more non-transitory computer-readable storage media) 1128 on which is stored one or more sets of instructions 1122 embodying any one or more of the methodologies or functions described herein. The instructions 1122 may also reside, completely or at least partially, within the main memory 1104 and/or within the processing device 1102 during execution thereof by the computer system 1100, the main memory 1104 and the processing device 1102 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), of temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Machine learning techniques may be employed to optimise any of the parameters of the present disclosure—such as any of the threshold values—through the training of a computational neural network on example training data, for example. As such, a database of past operations may be provided, either locally or at a remote content management system. Once the parameters have been trained by machine learning techniques for a given type or genre of audio track, further active machine learning need not be applied.

Unless specifically stated otherwise, as apparent from the following discussion, it is appreciated that throughout the description, discussions utilizing terms such as “receiving.” “determining,” “comparing,” “enabling.” “maintaining.” “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It will be understood that certain terminology is used in the preceding description for convenience and is not limiting. The terms “a,” “an,” and “the,” should be read as meaning “at least one” unless otherwise specified. The term “comprising” will be understood to mean “including but not limited to” such that systems or method comprising a particular feature or step are not limited to only those features or steps listed but may also comprise features or steps not listed. Equally, terms such as “over,” “under,” “front,” “back,” “right,” “left,” “top” “bottom,” “side,” “clockwise,” “anti clockwise,” and so on are used for convenience in interpreting the drawings and are not to be construed as limiting. Additionally, any method steps which are depicted in the figures as carried out sequentially, without causal connection, may alternatively be carried out in series in any order. Further, any method steps which are depicted as dashed or dotted flowchart boxes are to be understood as being optional.

The above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense.

### Clauses

1. A system for controlling a plurality of automated retail systems, comprising a controller in communication with a plurality of automated retail systems, wherein the controller is configured to:
   receive a user request to use the system,
   receive real time status information indicative of resource availability from the plurality of automated retail systems,
   determine an available product list, based on the received status information, wherein the available product list comprises a list of products which are available at the plurality of automated retail systems,
   transmit the available product list to the user,
   receive an order message comprising an order selected from the available product list from the user,
   select an automated retail system to fulfil the order, and
   transmit the order to the selected automated retail system.
2. The system according to clause 1, wherein the user request further comprises one or more of user location information, a user selected location and user preference information, and the product list is determined based on the received status information of automated retail systems associated with a location corresponding to the user request.
3. The system according to clause 2, wherein prior to determining the available product list. the controller is configured to query a work in progress data store for automated retail systems associated with the user location information.
4. The system according to clause 1 or clause 2, wherein the user request is received from a remote user device via an internet connection.
5. The system according to any preceding clause, wherein the status information comprises order state information relating to the orders the automated retail system is in the process of fulfilling.
6. The system according to any preceding clause, wherein the product list transmitted to the user comprises estimated wait time information for each product based at least in part on queue information.
7. The system according to any preceding clause, wherein prior to transmitting the order to the selected automated retail system, the controller is configured to place the received order in a queue of orders that the selected autonomous retail system is to fulfil.
8 The system according to clause 7, wherein the order message comprises a user timing request to preschedule an order, or delay an existing order, and the controller is arranged to place the order in the queue of orders based on the user timing request.
9. The system according to any preceding clause, wherein the product list is dynamically updated based on changes to the real time status information and transmitted to the user, and wherein optionally the available product list is determined based on the status information and one or both of the user location information and the location selection.
10. The system according to any preceding clause, wherein a first portion of the available products are available on a first automated retail system and a second portion of the available products are available on a second automated retail system.
11. The system according to any preceding clause, wherein the automated retail systems are automated retail kiosks, and optionally wherein the automated retail kiosks are automated beverage making machines.
12. The system according to any preceding clause, wherein the processor is configured to select a first automated retail system to fulfil a first part of the order, and a second automated retail system to fulfil a second part of the order.
13. The system according to any preceding clause, wherein the selecting of an automated retail system to fulfil the order is based on the user request and the status information to minimize the time taken to complete an order.
14. A method comprising, at a controller of a system of automated retail systems;
   receiving a user request to use the system,
   receiving real time status information indicative of product availability from a plurality of automated retail systems in communication with the controller,
   determining an available product list based on the received status information, the available product list comprising a list of products which are available at the plurality of automated retail systems,
   transmitting the available product list to the user,
   receiving an order message comprising an order selected from the available product list from the user,
   selecting an automated retail system to fulfil the order,
   transmitting the order to the selected automated retail system.
15. A computer readable medium comprising instructions which, when executed, cause a processor to perform the steps of the method of clause 14.

1. A system for controlling a plurality of automated retail systems, comprising a controller in communication with a plurality of automated retail systems, wherein the controller is configured to:
receive a user request to use the system,
receive real time status information indicative of resource availability from the plurality of automated retail systems,
determine an available product list, based on the received status information, wherein the available product list comprises a list of products which are available at the plurality of automated retail systems,
transmit the available product list to the user,
receive an order message comprising an order selected from the available product list from the user,
select an automated retail system to fulfil the order, and
transmit the order to the selected automated retail system.

2. The system according to claim 1, wherein the user request further comprises one or more of user location information, a user selected location and user preference information, and the product list is determined based on the received status information of automated retail systems associated with a location corresponding to the user request.

3. The system according to claim 2, wherein prior to determining the available product list, the controller is configured to query a work in progress data store for automated retail systems associated with the user location information.

4. The system according to claim 1, wherein the user request is received from a remote user device via an internet connection.

5. The system according to claim 1, wherein the status information comprises order state information relating to the orders the automated retail system is in the process of fulfilling.

6. The system according to claim 1, wherein the product list transmitted to the user comprises estimated wait time information for each product based at least in part on queue information.

7. The system according to claim 1, wherein prior to transmitting the order to the selected automated retail system, the controller is configured to place the received order in a queue of orders that the selected automated retail system is to fulfil.

8. The system according to claim 7, wherein the order message comprises a user timing request to preschedule an order, or delay an existing order, and the controller is arranged to place the order in the queue of orders based on the user timing request.

9. The system according to claim 2, wherein the product list is dynamically updated based on changes to the real time status information and transmitted to the user, and wherein optionally the available product list is determined based on the status information and one or both of the user location information and the location selection.

10. The system according to claim 1, wherein a first portion of the available products are available on a first automated retail system and a second portion of the available products are available on a second automated retail system.

11. The system according to claim 1, wherein the automated retail systems are automated retail kiosks, and optionally wherein the automated retail kiosks are automated beverage making machines.

12. The system according to claim 1, wherein the processor is configured to select a first automated retail system to fulfil a first part of the order, and a second automated retail system to fulfil a second part of the order.

13. The system according to claim 1, wherein the selecting of an automated retail system to fulfil the order is based on the user request and the status information to minimize the time taken to complete an order.

14. A method comprising, at a controller of a system of automated retail systems:
receiving a user request to use the system,
receiving real time status information indicative of product availability from a plurality of automated retail systems in communication with the controller,
determining an available product list based on the received status information, the available product list comprising a list of products which are available at the plurality of automated retail systems,
transmitting the available product list to the user,
receiving an order message comprising an order selected from the available product list from the user,
selecting an automated retail system to fulfil the order,
transmitting the order to the selected automated retail system.

15. A non-transitory computer readable medium comprising instructions which, when executed, cause a processor to perform the steps of the method of claim 14.
